(19) United States
(12) Patent Application Publication
(10) Pub. No.: US 2005/0161999 A1
(43) Pub. Date: Jul. 28, 2005

(54) Safety rim for vehicle wheel

(76) Inventor: Wen I Augustee Lee, Fullerton, CA (US)

Correspondence Address: RAYMOND Y. CHAN, 108 N. YNEZ AVE., SUITE 128, MONTEREY PARK, CA, 91754, US

(21) Appl. No.: 10/762,148

(22) Filed: Jan. 22, 2004

(51) Int. Cl. B60B 25/00

(52) U.S. Cl. 301/95.101; 301/95.109

(57) ABSTRACT

A vehicle rim includes a rim body and a safety rim. The rim body includes a hub and a tire locking frame coaxially mounted with the hub, wherein the tire locking frame has an outer circumferential wall and two locking flanges radially extended from two side edges of the outer circumferential wall for substantially interlocking with two beads of the wheel tire respectively. The safety rim, having a running surface, is radially and outwardly extended from the rim body, wherein a circumference of said safety rim is larger than a circumference of each of the locking flanges of the tire locking frame and is smaller than a circumference of the tread of the wheel tire, such that the safety rim functions as a safety wheel to support the rim body for running the running surface on the road surface when the wheel tire is popped out from the rim body.

### BACKGROUND OF THE PRESENT INVENTION

1. Field of Invention

The present invention relates to a wheel, and more particularly to a safety rim for a vehicle wheel which enhances the controllability and stability of the vehicle when the wheel tire thereof is accidentally broken during moving.

2. Description of Related Arts

Vehicles are necessity in the United Sates of America. A conventional vehicle wheel typically comprises a wheel rim and a wheel tire securely engaged therewith for rotatably supporting the vehicle to run on the road when the wheel tire is properly inflated with a predetermined safety pressure.

The wheel rim typically comprise a wheel hub connected with a driving axle of the vehicle in a rotatably movable manner, and a tire locking frame radially extended from the wheel hub for engaging with the wheel tire. As a matter of conventional art, the tire locking frame of the wheel rim has an outer circumferential wall and two locking flanges radially extended from two side edges of the outer circumferential walls for substantially interlocking with two beads of the wheel tire respectively, in such a manner that the wheel rim is adapted for coaxially and securely mounting to the wheel tire under the predetermined safety pressure so as to substantially support a tread of the wheel tire to run on a road surface.

Notwithstanding there exist much technological improvement in the wheel tire and the wheel rim themselves, which cater for a wide variety of situations, some discrepancies still exist and need further development. One of the most disastrous discrepancies is that the traditional design of the conventional vehicle wheel, such as the above-mentioned vehicle wheel, may present a very dangerous scenario in certain common situations in relation to vehicles.

Specifically, the above-mentioned conventional vehicle wheel is extremely dangerous when the wheel tire is accidentally broken during the course of the vehicle's moving. Each of the two locking flanges has an outer edge formed at the outmost surface thereof so that when the wheel tire is accidentally broken, the pressurized air inflated into the wheel tire will come out to the atmosphere immediately, causing the wheel tire to collapse. As a result, the two locking flanges will be forced to be in contact, either directly or via the collapsed tire, with the ground on which the vehicle is moving.

When the vehicle is moving in a genuine low speed, it should not be a serious problem for the driver to steer the vehicle aside the road and then to replace the damaged tire. However, and very often, when the vehicle is moving at a fairly high speed, or even that the vehicle is moving very fast on a freeway, the consequence of broking the wheel tire may be totally different. Since the vehicle is moving at a very high speed, when the locking flanges are in contact with the road surface, it is very likely that they will cut into the road surface so as to form a track thereon dictating the direct of moving. As a result, the driver will be unable, because of the indention of the track formed on the ground, to turn the vehicle wheel with a view to steer the vehicle aside the road, thus leaving the vehicle in a very dangerous situation and the driver no longer gains control to it.

It is worth to mention that this scenario is further worsen when the vehicle is a heave-duty vehicle, such as a sport utility vehicle, in which a center of mass of the vehicle is higher than that of a compact vehicle, meaning that the vehicle is easier to flip over when the locking flanges of the wheel rim are cut onto the road surface, as a result of a substantial momentum change.

Moreover, since the wheel rim is cut into the road, it is highly likely that the wheel rim, especially the two locking flanges, will be substantially distorted so that it is no longer useful for a vehicle. When the car is eventually stopped aside of the road, this even means that the vehicle needs towing. Merely replacing the damaged tire would be insufficient.

### SUMMARY OF THE PRESENT INVENTION

A main object of the present invention is to provide a safety rim for a vehicle which is capable of enhancing the controllability and stability of the vehicle when the wheel tire thereof is accidentally broken in the course of its moving.

Another object of the present invention is to provide a safety rim for a vehicle wheel of a vehicle, which is capable of preventing a rim body of the vehicle from cutting into the road surface on which the vehicle is moving when the wheel tire thereof is accidentally broken, so that the driver of the vehicle can be able to resume control of the vehicle, thus minimizing the seriousness of the consequences of the accident.

Another object of the present invention is to provide a safety rim for a vehicle which is outwardly extended from a rim body of the vehicle in such a manner that when the wheel tire is broken, the safety rim will act as a safety wheel running on the ground, thus avoiding the rim body from contacting with the ground so as to prevent damage thereto, such as distortion.

Another object of the present invention is to provide a safety rim for a vehicle which does not alter the original design of a vehicle rim so as to minimize the manufacturing cost and the ultimate selling price of the present invention.

Another object of the present invention is to provide a safety rim for a vehicle which does not involve complicated mechanical components and operational processes so as to maximize the compatibility of the present invention for suiting a wide variety of vehicles.

Accordingly, in order to accomplish the above objects, the present invention provides a vehicle rim for supporting a tire of a vehicle, comprising:
a rim body comprising a hub adapted for rotatably connecting to the vehicle, and a tire locking frame, having a U-shaped cross section, coaxially mounted with the hub, wherein the tire locking frame has an outer circumferential wall and two locking flanges radially extended from two side edges of the outer circumferential wall for substantially interlocking with two beads of the wheel tire respectively, in such a manner that the rim body is adapted for coaxially and securely mounting to the wheel tire under a safety pressure so as to substantially support a tread of the wheel tire to run on a road surface; and
a safety rim, having an outer running surface, radially and outwardly extended from the rim body, wherein a circumference of the safety rim is larger than a circumference of each of the locking flanges of the tire locking frame and is smaller than a circumference of the tread of the wheel tire, such that the safety rim functions as a safety wheel to support the rim body for running the running surface on the road surface when the wheel tire is popped out from the rim body.

Moreover, the present invention further provides a vehicle wheel for a vehicle, comprising:
a wheel tire having two engaging beads and a tread adapted for running on a road surface; and
a vehicle rim, which comprises:
a rim body comprising a hub adapted for rotatably connecting to the vehicle, and a tire locking frame, having a U-shaped cross section, coaxially mounted with the hub, wherein the tire locking frame has an outer circumferential wall and two locking flanges radially extended from two side edges of the outer circumferential wall for substantially interlocking with the two beads of the wheel tire respectively, in such a manner that the rim body is adapted for coaxially and securely mounting to the wheel tire under a safety pressure so as to substantially support the tread of the wheel tire to run on the road surface; and
a safety rim, having an outer running surface, radially and outwardly extended from the rim body, wherein a circumference of the safety rim is larger than a circumference of each of the locking flanges of the tire locking frame and is smaller than a circumference of the tread of the wheel tire, such that the safety rim functions as a safety wheel to support the rim body for running the running surface on the road surface when the wheel tire is popped out from the rim body.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a vehicle wheel according to a first preferred embodiment of the present invention.

FIGS. 2A and 2B are sectional views of the vehicle wheel according to the above first preferred embodiment of the present invention.

FIG. 3A and FIG. 3B are schematic diagrams of the operation of the safety rim according to the above first preferred embodiment of the present invention.

FIGS. 4A and 4B illustrate the safety rim incorporating with different kinds of wheel rim according to the above first preferred embodiment of the present invention.

FIGS. 5A and 5B are sectional views of a vehicle wheel according to a second preferred embodiment of the present invention.

FIGS. 6A through 6C illustrate the safety rim incorporating with different kinds of wheel rim according to the above second preferred embodiment of the present invention.

### DETAILED DESCRIPTION OF THE PREFERRED EMBODIMENT

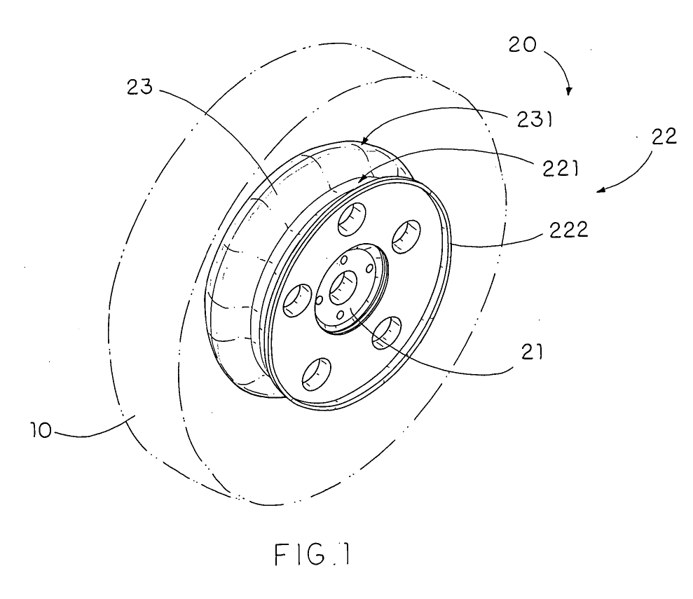

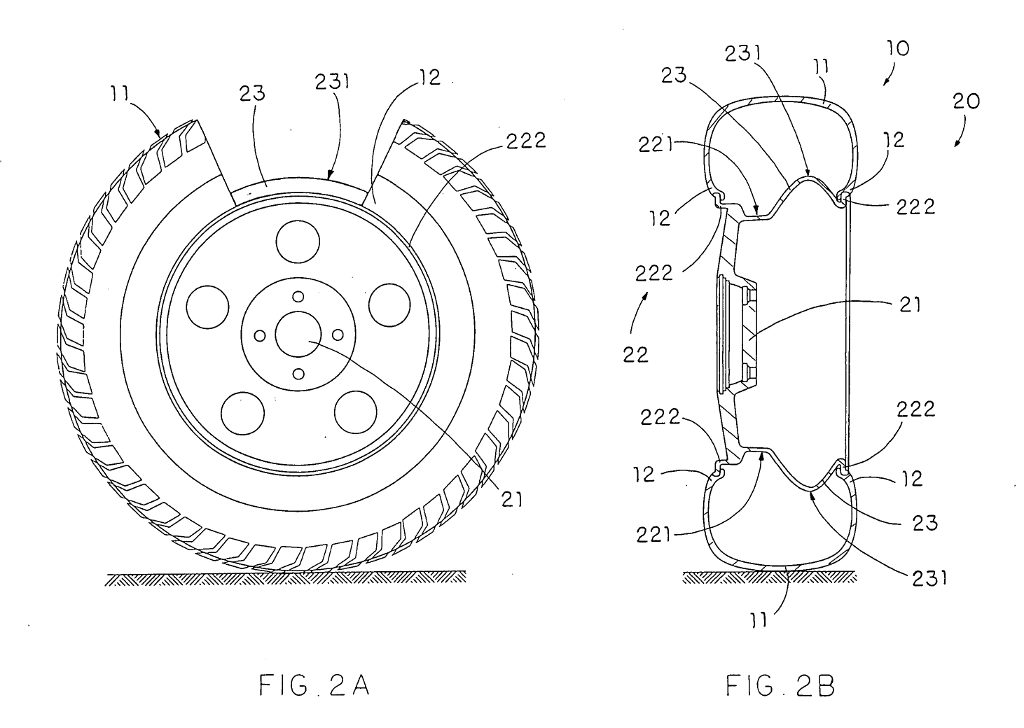

Referring to FIGS. 1, 2A and 2B of the drawings, a vehicle wheel 1 for a vehicle according to a preferred embodiment of the present invention is illustrated, wherein the vehicle comprises an engine, and a driving axle rotatably driven by the engine for rotatably driving the vehicle wheel to rotate and run on a road surface. The vehicle wheel comprises a wheel tire 10, and a vehicle rim 20.

The wheel tire 10, such as a regular tire having a U-shaped cross section, comprises an annular tread 11 and two beads 12, wherein the tread 11 has a plurality of grooves formed thereon to contact with the road surface so as to minimize the risk of skidding. The wheel tire 10 further has two circular beads 12 structured with high tensile strength and functioned as anchors for holding the wheel tire onto the vehicle rim 20.

According to the preferred embodiment, the vehicle rim 20 comprises a rim body which comprises a hub 21 adapted for connecting to the driving axle of the vehicle 80, and a tire locking frame 22 coaxially extended from the hub 21 for coaxially mounting to the wheel tire 10.

The tire locking frame 22, having a U-shaped cross section, has an outer circumferential wall 221 and two locking flanges 222 radially extended from two side edges of the outer circumferential wall 221 to define an interlocking cavity within the outer circumferential wall 221 and the two locking flanges 222. Moreover, the two locking flanges 222 are arranged to substantially interlock with the beads 12 of the wheel tire 10 respectively, in such a manner that the rim body is adapted for coaxially and securely mounting to the wheel tire 10 under a predetermined safety pressure, such as a regular tire pressure, so as to substantially support the annular tread 11 of the wheel tire 10 to run on the road surface.

The vehicle rim 20 further comprises a safety rim 23, having a running surface 231, radially and outwardly extended from the rim body, wherein a circumference of the safety rim 23 is larger than a circumference of each of the locking flanges 222 of the tire locking frame 22 and is smaller than a circumference of the annular tread 11 of the wheel tire 10, such that the safety rim 23 functions as the safety wheel to support the rim body for running the running surface 231 on the road surface when the wheel tire 10 is popped out from the rim body.

As shown in FIGS. 2A and 2B, the safety rim 23, which is made of rigid, durable but lightweight material, is radially and outwardly extended from the outer circumferential wall 221 between the two locking flanges 222, wherein the running surface 231 of the safety rim 23 is coaxially positioned between a top edge of each of the locking flanges 222 and the tread 11 of the wheel tire 10.

The running surface 231 of the safety rim 231 is formed on an outer circumferential surface thereof and is in round shape, wherein the running surface 231 of the safety rim 23 is adapted for substantially supporting the vehicle rim 20 to run on the road surface when the wheel tire 10 is popped out from the rim body. In other words, the safety rim 23 is protruded out of the interlocking cavity such that, with the absence of the wheel tire 10, such as when the wheel tire 10 is accidentally broken or exploded, the safety rim 23 will represent the outermost rim as the safety wheel of the vehicle rim 20.

According to the preferred embodiment, the safety rim 23 is integrally extended from the outer circumferential wall of the rim body, wherein an outer circumferential surface of the safety rim 23 forms as the running surface 231 for running on the road surface when the wheel tire 10 is popped out from the rim body.

Furthermore, a width of the safety rim 23 is gradually reducing from the outer circumferential wall of the rim body to the running surface 231. Therefore, the safety rim 23 does not interfere with the mounting of the wheel tire 10 to the vehicle rim 20.

Accordingly, the safety rim 23 will function as a safety wheel when the wheel tire 10 is accidentally broken or exploded, such that the driver of the vehicle is able to gain control to the vehicle and steer the vehicle aside road for repairing. It is worth to mention that the circumferential size of the safety rim 23 is slightly larger than the circumferential size of each of the locking flanges 222 such that the wheel tire 10 can be normally replaced through the conventional replacement operation.

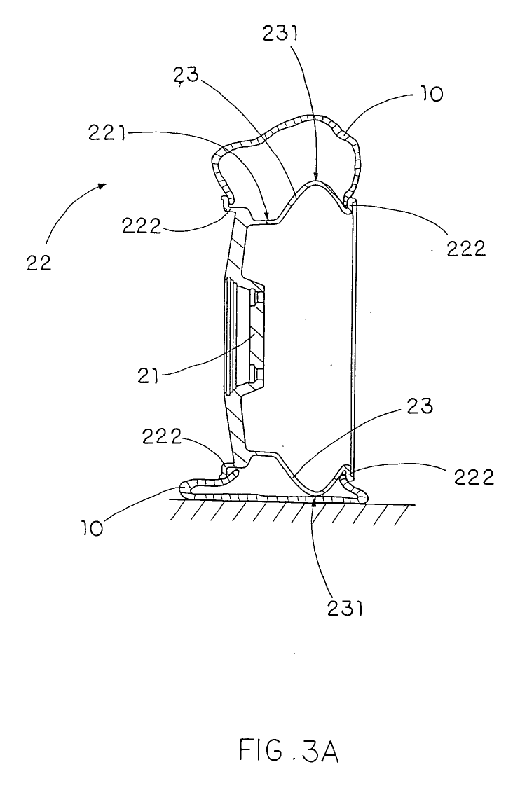

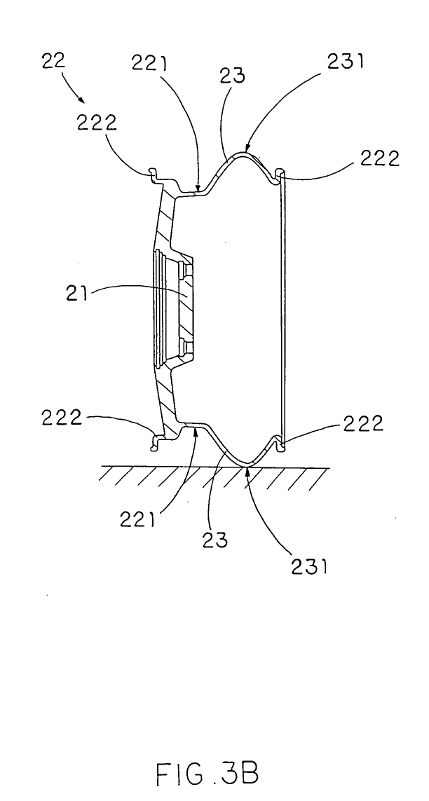

As shown in FIG. 3A, when the vehicle tire 10 goes flat, the tread 11 of the vehicle tire 10 is firstly pressed to contact with the running surface 231 of the safety rim 23 such that the running surface 231 of the safety rim 23 runs on the road surface while the flat vehicle tire 10 wraps around the safety rim 23. Therefore, the safety rim 23 not only prevents the locking flanges 222 from directly contacting with the road surface but also prevents the flat vehicle tire 10 detaching from the rim body.

As shown in FIG. 3B of the drawings, when the wheel tire 10 is exploded, the vehicle rim 20 will directly contact with the road surface. As mentioned in the background, in the absence of the safety rim 23, the locking flanges 222 will cut into the road surface, so that the vehicle will eventually lose control thereof. However, when the vehicle rim 20 incorporates with the safety rim 23, the safety rim 23 becomes the safety wheel of the vehicle rim 20 to contact with the road surface and run thereon. Since the running surface 231 of the safety rim 23 is embodied as a rounded surface, it would not cut into the ground and instead facilitate running of the vehicle rim 20 over it. As a result, the vehicle will be gained control such that the driver is able to steer the vehicle aside of the road for further repairing, such as replacement of the wheel tire 10. Moreover, note that during the above-mentioned operation, the rim body will not be substantially distorted in structure so that no replacement of the rim body is necessary.

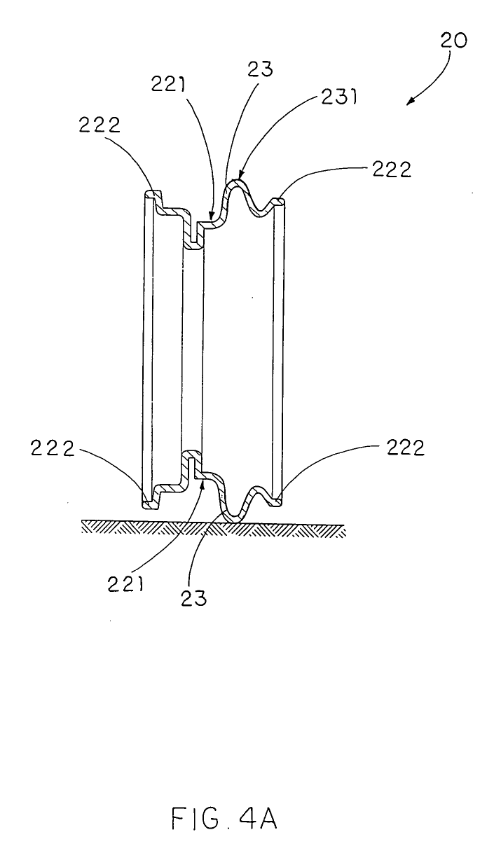

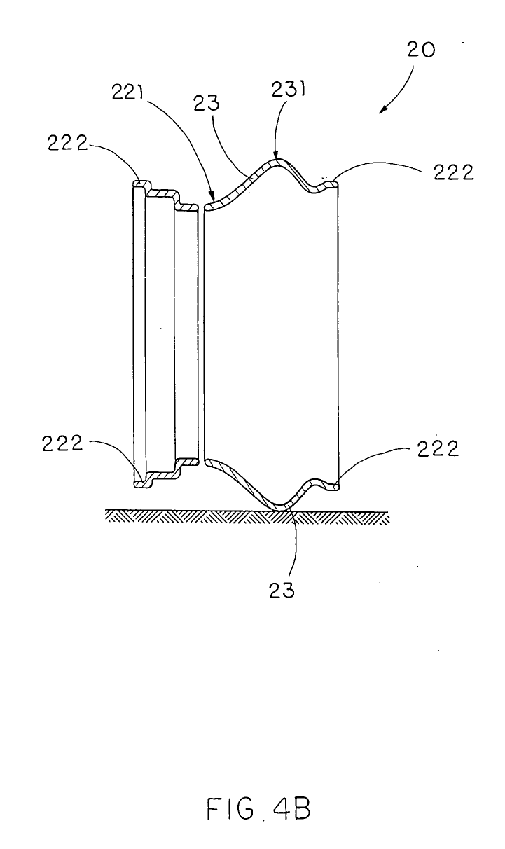

FIGS. 3B, 4A and 4B illustrates the safety rim 23 can be incorporated with any kind of the wheel rim 20 wherein the wheel rim 20 can be a one-piece type wheel rim as shown in FIG. 3B, a two-piece type wheel rim as shown in FIG. 4A, or a three-piece sandwich type wheel rim as shown in FIG. 4B. Therefore, the safety rim 23 is adapted to integrally form on any size of the wheel rim 20 to incorporate with the vehicle from a compact car to a truck.

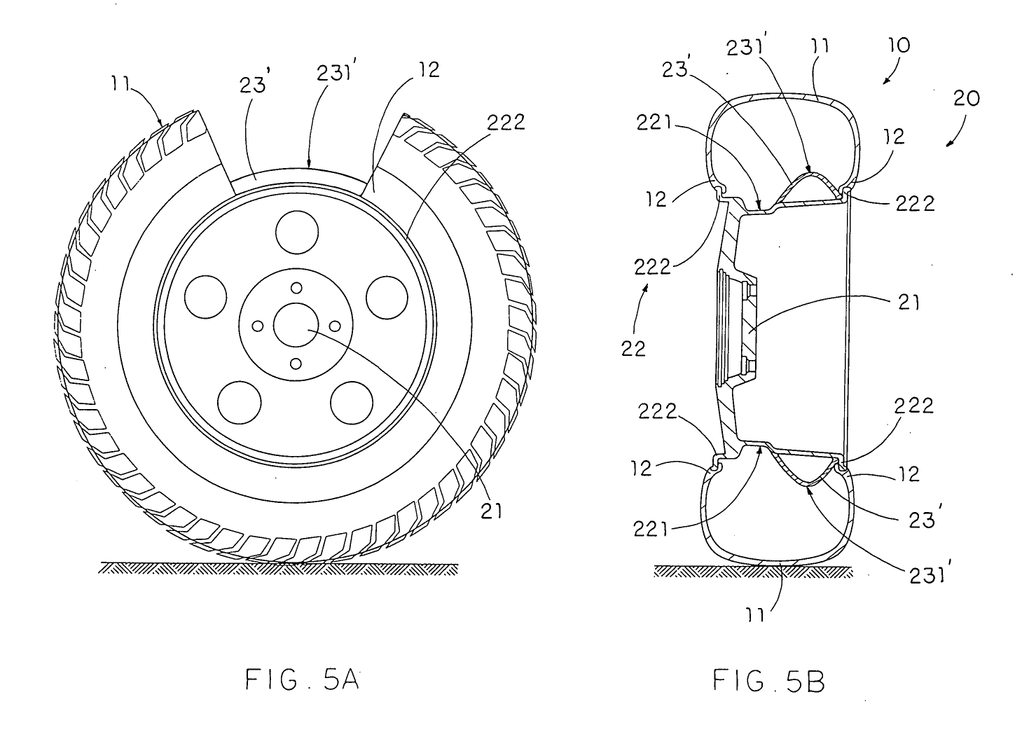

FIGS. 5A and 5B illustrate an alternative mode of the safety rim 23′ according to the above preferred embodiment of the present invention, wherein the safety rim 23′, having a ring shaped, is radially and outwardly attached to the outer circumferential wall 221 between the two locking flanges 222.

As shown in FIG. 4, the safety rim 23′ has an inner circumferential surface securely attached to the outer circumferential wall 221 of the rim body and an outer circumferential surface forming as the running surface 231′ having a round shaped. Accordingly, a width of the safety rim 23′ is gradually reducing from the outer circumferential wall 221 of the rim body to the running surface 231′.

Accordingly, the safety rim 23′ is made of rigid but light weight material, such as alloy, to radially attach on the rim body to form the safety wheel. In addition, the safety rim 23′ can be made of elastic yet durable materials, such as rubber, and is adapted to be mounted on the outer circumferential wall 221 in order to form the safety wheel. In other words, the rubber made safety rim 23′ can be slightly deformed to increase the circumference thereof for wrapping around the outer circumferential wall 221 of the rim body. Therefore, the safety rim 23′ is capable of incorporating with the conventional rim body having the outer circumferential wall 221.

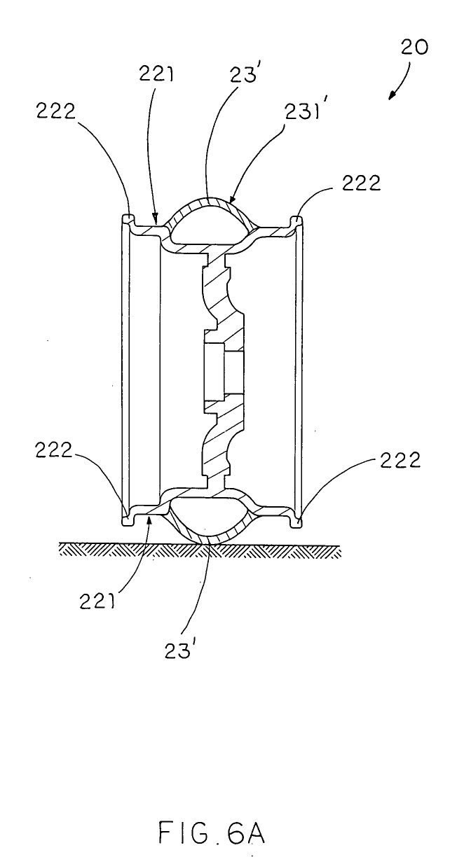

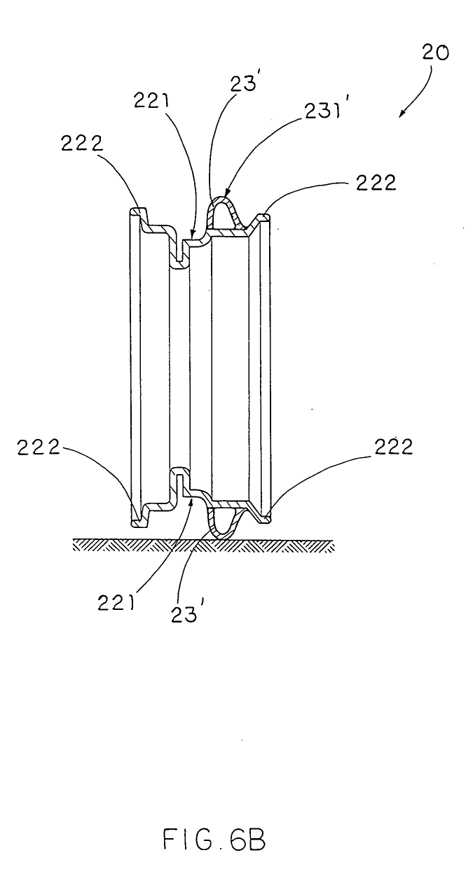

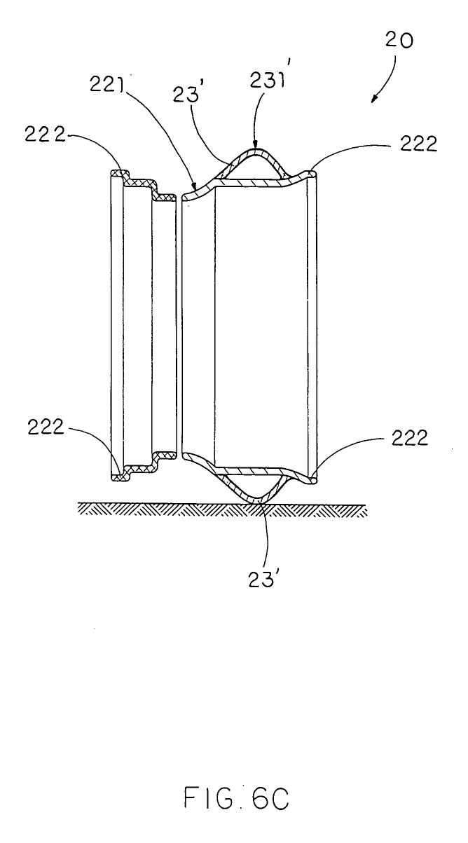

FIGS. 6A through 6C illustrates the safety rim 23′ can be incorporated with any kind of the wheel rim 20′ wherein the wheel rim 20′ can be a one-piece type wheel rim as shown in FIG. 6A, a two-piece type wheel rim as shown in FIG. 6B, or a three-piece sandwich type wheel rim as shown in FIG. 6C. Therefore, the safety rim 23′ is adapted to attach to any size of the wheel rim 20′ to incorporate with the vehicle from a compact car to a truck.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A vehicle rim for supporting a tire of a vehicle, comprising:
a rim body comprising a hub adapted for rotatably connecting to the vehicle, and a tire locking frame, having a U-shaped cross section, coaxially mounted with said hub, wherein said tire locking frame has an outer circumferential wall and two locking flanges radially extended from two side edges of said outer circumferential wall for substantially interlocking with two beads of said wheel tire respectively, in such a manner that said rim body is adapted for coaxially and securely mounting to said wheel tire under a safety pressure so as to substantially support a tread of said wheel tire to run on a road surface; and
a safety rim, having a running surface, radially and outwardly extended from said rim body, wherein a circumference of said safety rim is larger than a circumference of each of said locking flanges of said tire locking frame and is smaller than a circumference of said tread of the wheel tire, such that said safety rim functions as a safety wheel to support said rim body for running said running surface on said road surface when said wheel tire is popped out from said rim body.

2. The vehicle rim, as recited in claim 1, wherein said safety rim is radially and outwardly extended from said outer circumferential wall between said two locking flanges, wherein said running surface of said safety rim is coaxially positioned between a top edge of each of said locking flanges and said tread of said wheel tire.

3. The vehicle rim, as recited in claim 2, wherein said running surface of said safety rim is a rounded surface adapted for substantially supporting said vehicle rim to run on said road surface when said wheel tire is popped out from said rim body.

4. The vehicle rim, as recited in claim 1, wherein said safety rim is integrally extended from said outer circumferential wall of said rim body so as to form an integral wheel of said rim body, wherein an outer circumferential surface of said safety rim forms as said running surface thereof for running on said road surface when said wheel tire is popped out from said rim body.

5. The vehicle rim, as recited in claim 3, wherein said safety rim is integrally extended from said outer circumferential wall of said rim body so as to form an integral wheel of said rim body, wherein an outer circumferential surface of said safety rim forms as said running surface thereof for running on said road surface when said wheel tire is popped out from said rim body.

6. The vehicle rim, as recited in claim 4, wherein a width of said safety rim is gradually reducing from said outer circumferential wall of said rim body to said running surface.

7. The vehicle rim, as recited in claim 5, wherein a width of said safety rim is gradually reducing from said outer circumferential wall of said rim body to said running surface.

8. The vehicle rim, as recited in claim 1, wherein said safety rim, having a ring shaped, has an inner circumferential surface securely attached to said outer circumferential wall of said rim body and an outer circumferential surface forming as said running surface.

9. The vehicle rim, as recited in claim 3, wherein said safety rim, having a ring shaped, has an inner circumferential surface securely attached to said outer circumferential wall of said rim body and an outer circumferential surface forming as said running surface.

10. The vehicle rim, as recited in claim 8, wherein a width of said safety rim is gradually reducing from said outer circumferential wall of said rim body to said running surface.

11. The vehicle rim, as recited in claim 9, wherein a width of said safety rim is gradually reducing from said outer circumferential wall of said rim body to said running surface.

12. A vehicle wheel for a vehicle, comprising:
a wheel tire having two beads and a tread adapted for running on a road surface; and
a rim body comprising a hub adapted for rotatably connecting to said vehicle, and a tire locking frame, having a U-shaped cross section, coaxially mounted with said hub, wherein said tire locking frame has an outer circumferential wall and two locking flanges radially extended from two side edges of said outer circumferential wall for substantially interlocking with said two beads of said wheel tire respectively, in such a manner that said rim body is coaxially and securely mounted to said wheel tire under a safety pressure so as to substantially support said tread of said wheel tire for running on said road surface; and
a safety rim, having a running surface, radially and outwardly extended from said rim body, wherein a circumference of said safety rim is larger than a circumference of each of said locking flanges of said tire locking frame and is smaller than a circumference of said tread of said wheel tire, such that said safety rim functions as a safety wheel to support said rim body for running said running surface on said road surface when said wheel tire is popped out from said rim body.

13. The vehicle wheel, as recited in claim 12, wherein said safety rim is radially and outwardly extended from said outer circumferential wall between said two locking flanges, wherein said running surface of said safety rim is coaxially positioned between a top edge of each of said locking flanges and said tread of said wheel tire.

14. The vehicle wheel, as recited in claim 13, wherein said running surface of said safety rim is a rounded surface adapted for substantially supporting said vehicle rim to run on said road surface when said wheel tire is popped out from said rim body.

15. The vehicle wheel, as recited in claim 12, wherein said safety rim is integrally extended from said outer circumferential wall of said rim body so as to form an integral wheel of said rim body, wherein an outer circumferential surface of said safety rim forms as said running surface thereof for running on said road surface when said wheel tire is popped out from said rim body.

16. The vehicle wheel, as recited in claim 14, wherein said safety rim is integrally extended from said outer circumferential wall of said rim body so as to form an integral wheel of said rim body, wherein an outer circumferential surface of said safety rim forms as said running surface thereof for running on said road surface when said wheel tire is popped out from said rim body.

17. The vehicle wheel, as recited in claim 15, wherein a width of said safety rim is gradually reducing from said outer circumferential wall of said rim body to said running surface.

18. The vehicle wheel, as recited in claim 16, wherein a width of said safety rim is gradually reducing from said outer circumferential wall of said rim body to said running surface t.

19. The vehicle wheel, as recited in claim 12, wherein said safety rim, having a ring shaped, has an inner circumferential surface securely attached to said outer circumferential wall of said rim body and an outer circumferential surface forming as said running surface.

20. The vehicle wheel, as recited in claim 14, wherein said safety rim, having a ring shaped, has an inner circumferential surface securely attached to said outer circumferential wall of said rim body and an outer circumferential surface forming as said running surface.

21. The vehicle wheel, as recited in claim 19, wherein a width of said safety rim is gradually reducing from said outer circumferential wall of said rim body to said running surface.

22. The vehicle wheel, as recited in claim 20, wherein a width of said safety rim is gradually reducing from said outer circumferential wall of said rim body to said running surface.
